(19) United States
(12) Patent Application Publication
(10) Pub. No.: US 2014/0338297 A1
(43) Pub. Date: Nov. 20, 2014

(54) ARTIFACT FREE INERT FILTER MEDIUM FOR COLLECTION OF ORGANIC PARTICLES

(71) Applicant: U.S. Environmental Protection Agency, Washington, DC (US)

(72) Inventor: Paul A. SOLOMON, Henderson, NV (US)

(73) Assignee: U.S. Environmental Protection Agency, Washington, DC (US)

(21) Appl. No.: 14/281,626

(22) Filed: May 19, 2014

Related U.S. Application Data
(60) Provisional application No. 61/855,514, filed on May 17, 2013.

(51) Int. Cl. B01D 39/20

(52) U.S. Cl. CPC B01D 39/2068
USPC 55/523

(57) ABSTRACT

An artifact free inert filter medium for collection of organic particles is a fibrous material is developed that can be formed into filters used in ambient and indoor air sampling equipment for subsequent laboratory chemical analysis by one of several thermal optical or thermal analysis methods for the determination of organic carbon (OC), elemental carbon (EC), pyrolysis carbon (PC), and total carbon (TC, sum of OC+EC), carbon fractions determined by thermal or thermal-optical analysis methods (OC1, OC2, OC3, OC4, PC, EC1, EC2, EC3) as well can be analyzed in the laboratory for individual organic species by a range of thermal analysis and or extraction/analysis methods.

### CROSS-REFERENCE TO RELATED APPLICATIONS

This application claims priority to provisional U.S. application Ser. No. 61/855,514, filed May 17, 2013, in the United States Patent and Trademark Office. All disclosures of the document(s) named above are incorporated herein by reference.

### BACKGROUND OF THE INVENTION

Carbon exists in the atmosphere in two phases, gaseous and condensed. The condensed phase exists as liquid or solid particles. The organic carbon in the condensed phase may be referred to as particulate organic carbon (OC) and the collection of OC by filtration of ambient or indoor aerosol independent of interferences from the gas phase is the primary objective of this work. It is the purpose of this invention to provide artifact free filters be useful for identifying particular forms of carbon: of organic carbon (OC), elemental carbon (EC), pyrolysis carbon (PC), and total carbon (TC, sum of OC+EC), thermal analysis method carbon fractions (OC1, OC2, OC3, OC4, PC, EC1, EC2, EC3) as well as for analysis in the laboratory for individual organic species by a range of thermal analysis and or extraction/analysis methods. Prior filters, while useful for less exacting analysis of organic carbon, did not provide for the differentiation between the particle phase and gas phase desired due to a proclivity for sorbing organic gases. Hence, there are prepared filters having a fibrous ceramic component and a coating treated with inert nanoparticles or an inorganic inert vapor for monitoring ambient environments for determination of carbon fractions.

U.S. Pat. Nos. 4,376,675 and 4,687,579 teach ways for making a filter which can presently be used for less sensitive and less selective analyses. However, they do not provide for the more selective analysis desired, and for which the filters of the present invention are prepared. Maimone (Maimone F., Turpin B. J., Meng Q. Y., Summary Solomon P. A., Robinson A. L., Subramanian R., and Polidori A. Correction Methods for Organic Carbon Artifacts When Using Quartz-Fiber Filters in Large Particulate Matter Monitoring Networks: The regression method and other options. J. Air Waste Manage Assoc., 61:696-710, 2011.) describes the problems which the presently disclosed invention is designed to address.

Prior art filters are made by several companies Some made by Pallflex® Tissuquartz™ and sold by Pall Life are 100% SiO₂ are free of binder with a particle collection efficiency of 99.99%. They are a random fiber filter as shown in FIG. 2. Whatman makes a similar filter: Grade QM-A Quartz Filter 4.7 cm diameter. For exacting air pollution monitoring especially critical analyses and trace level determinations by thermal optical absorption (TOA) as well as other techniques such as atomic absorption spectroscopy and flame emission spectrometry used in PM10 and PM2.5 air sampling testing. Fine porosity. 99.999% particle retention. (Whatman 1851-047). Unifrax I LLC, Tonawanda N.Y. sells ceramic fibers loose or in sheets that can be cut to any size but they have never been used for air sampling and subsequent chemical analysis of carbonaceous material found in ambient and indoor air. The sheets I've seen that are suitable from a structural standpoint contain an organic binder which we cannot have with the new filter. Ones without the organic binder are not structurally sound. Unifrax, for example, has a process for making sheets from the fibers and that can be as simple as pressing the fibers in an aqueous or other solution or as annealing or sintering the fibers at a specified temperature as the sheets are being formed. When one type of the loose fibers without the binder was tested they still absorbed organic gases. However, the company thought they could modify the fibers to be inert by how the fibers are formed, by treating with the fibers with an inorganic material (perhaps a metal nanoparticle or an inorganic inert vapor that does not oxidize over time), or some other agent.

### SUMMARY OF THE INVENTION

Aspects of the present invention relate to artifact free filters. A fibrous material is developed that can be formed into filters used in ambient and indoor air sampling equipment for subsequent laboratory chemical analysis by one of several Thermal optical or thermal analysis methods for the determination of organic carbon (OC), elemental carbon (EC), pyrolysis carbon (PC), and total carbon (TC, sum of OC+EC), carbon fractions determined by thermal or thermal-optical analysis methods (OC1, OC2, OC3, OC4, PC, EC1, EC2, EC3) as well can be analyzed in the laboratory for individual organic species by a range of thermal analysis and or extraction/analysis methods. The filter can be used in continuous or semi-continuous samplers that measure OC, EC, PC, TC, OC and EC fractions, and OC species as well. The filter may be constructed from ceramic fibrous materials, other inert or refractory materials, a fiber that can be coated or treated to be inert, such as fibers coated with inert nanoparticles (metal or other) or made passive by interaction with a gas. Coatings and or filters should not be composed of metal oxides that can decompose below 1200° C. since the oxygen released would interfere with thermal or thermal-optical methods currently employed.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a rigid filter for use in conventional testing apparatus; and

FIG. 2 is a filter that is 100% SiO₂ and are free of binder.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

As indicated above, there is need for improved methods for evaluating carbon content in the environment. Several filters are available, and methods of making are known in the art. For example, the following methods are appropriate for practice of the invention. These methods are used for making the newer filters that are the subject of this application.

In the art of forming filters, it is often that a filter is formed from an aqueous slurry containing an admixture of both low-melting-point binder and high-melting-point filter fibers, and, thereafter, heating the filter to a temperature greater than the temperature of the low-melting-point fibers and less than the temperature of the high-melting-point fibers, to effect melting of the low-melting-point fibers, the molten material of the low-melting point fibers forming at the crossover points of the high-melting-point fibers to act as a bonding agent, thereby preparing a nonwoven, self-supporting, fibrous filter composed of the filter fibers.

In an embodiment of the invention a particulate filter medium is formed of a sintered composite of 0.5 micron diameter quartz fibers and 2 micron diameter stainless steel fibers. A preferred composition is about 40 vol. % quartz and about 60 vol. % stainless steel fibers. The media is sintered at about 1100° C. to bond the stainless steel fibers into a cage network which holds the quartz fibers. High filter efficiency and low flow resistance are provided by the smaller quartz fibers. High strength is provided by the stainless steel fibers. The resulting media has a high efficiency and low pressure drop similar to the standard HEPA media, with tensile strength at least four times greater, and a maximum operating temperature of about 550° C.

Aspects of the invention also include methods to form the composite media and a HEPA filter utilizing the composite media. Filters can be used for particle collection. Nanoparticles, such as an inert transition metals (e.g., titanium, tungsten, platinum) could be used which would be allowed to interact with the invention. In another embodiment of the invention transition metals also could be applied through vapor deposition from the gas phase coating the particles evenly.

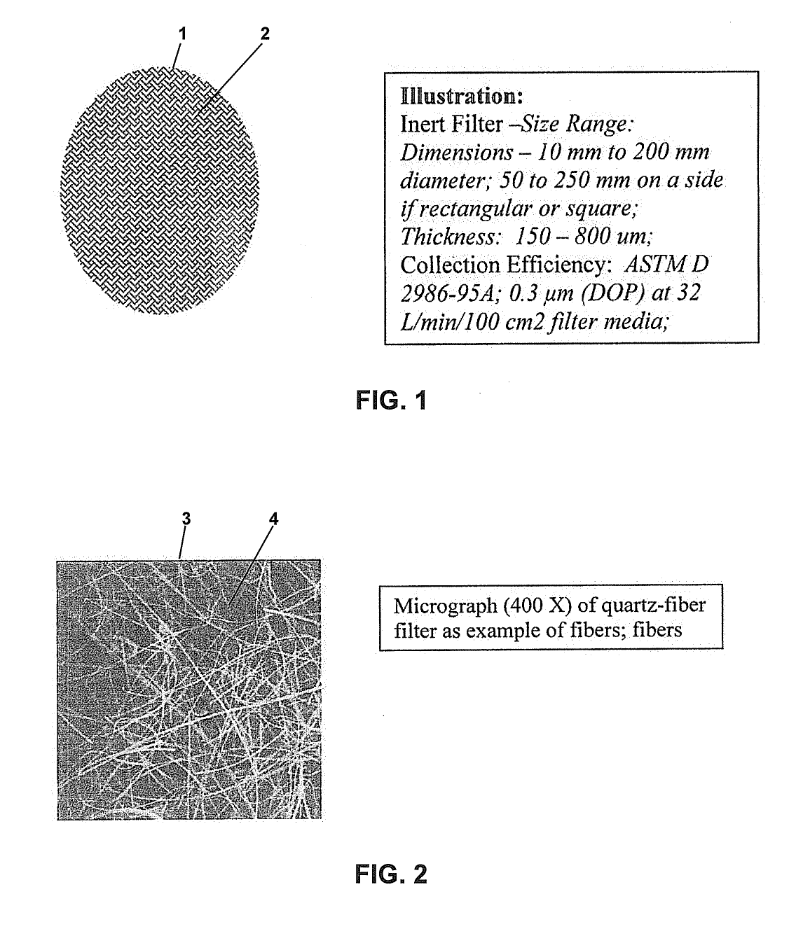

FIG. 1 shows a common configuration for a filter (1) with a cross-hatch designed interior (2). This configuration is appropriate for use in the present invention. FIG. 2 shows a filter (3) that is free of binder with a particle collection efficiency of 99.99%. The random fibers (4) are shown. This is an alternative design for a filter for use in the present invention provided there is sufficient rigidity.

The new filters are usually made of fibrous material that will not adsorb or absorb organic gases (<0.008 μg/cm² of filter material similar in size to the 47 mm quartz-fiber filter either passively or during sampling, e.g., a range from 0.1 L/min to 1200 L/min) and can be heated to at least 1100° C. The analytical minimum detection limit at the 10th percentile based on a six year average is 0.080 μg/cm² and at the 50th percentile it is 0.196 μg/cm2. The average OC artifact falls toward the 50th percentile of the MDL range (Maimone et al. 2011). The goal is to ensure an artifact level 10 times lower than the MDL at the 10^{th} percentile. The filter (e.g., 47 mm) has a low-pressure drop of no more than 25 inches of water at 16.7 L/min and is similar in thickness to the currently used quartz-fiber filter. Higher pressure drops at a range of flow rates may be acceptable since higher pressure drops result in lower organic sampling artifacts overall. The filter material collects ambient PM with at least as good a collection efficiency as quartz-fiber filters, which are currently employed in EPA's national chemical speciation monitoring networks. This is typically >99.99% collection efficiency at 300 nm diameter particles. The filter is to be made of material that will not adsorb or absorb organic gases (<0.008 μg/cm² of collection area) and can be heated to at least 1100° C.

The filter sizes include, but are not limited to 10 mm, 25 mm, 37 mm, 47 mm, 90 mm in diameter, and ˜20×25 cm². Other sizes may be needed. The filter must be free of any organic binding agents and can be analyzed by easily punching a sample (typically 1 to 1.5 cm2) from the filter, without shattering or creating filter dust in the process and without losing sample from the filter. The filter can be placed into and out of an appropriate filter holder without losing collected sample or filter material, although a small loss around the edges where the filter is held by the filter holder is acceptable but the filter cannot be weighed due to this minor loss of fibers. However, it is most beneficial if the filter could be weighed (no loss of fibers) on a microbalance similar to 47 mm Teflon filters with similar or better accuracy and precision. Weighing the filter is an optional requirement of the filter. The product filter will be for use in field studies of ambient and indoor environments to determine the chemical composition of the carbonaceous fraction of PM in air that will help to link ambient environment.

The filters according to aspects of the invention may be ways by usual means known in the art. For example, one way is disclosed in U.S. Pat. No. 4,687,579, which is incorporated herein by reference in its entirety. While the methods of the cited patent use quartz, the ceramic materials identified as useful for the practice of the present invention can be processed using that general manner. A product for use in making the instantly claimed invention is ceramic fiber Fiberfax made by Unifrax. However, other known methods than those in the cited application may be used for making the products of the invention.

U.S. Pat. No. 4,376,675 to Perrotta (which is incorporated herein in its entirety) describes means of making tubular filter means. The product is made from a slurry. The support is semirigid method of preparing a nonwoven, fibrous, self-supporting, semirigid, all-inorganic, silicate-bound, filter tube consisting essentially of a plurality of interrelated, nonwoven fibers having interstices there between, the fibers bonded at the crossover points of the fibers with a bonding agent, which method comprises preparing an aqueous slurry comprising an admixture of low-melting-point, glass-binder fibers and high-melting-point, inorganic, filter fibers, the difference in melting point being greater than 1000° F., the glass-binder fibers being present in an amount sufficient to act as a bonding agent for the inorganic filter fibers, the inorganic fibers being present in an amount sufficient to provide for a formed, porous, filter.

Filters of the invention maybe coated using transition metal vapors such as titanium, tungsten, and platinum vapor in order to increase effectiveness. Other inerting materials can be used.

The fibrous materials formed into filters used in ambient and indoor air would also be used in sampling equipment for subsequent laboratory chemical analysis by one of several thermal or thermal optical analysis (T/TOA) methods for the determination of organic carbon (OC), elemental carbon (EC), pyrolysis carbon (PC), and total carbon (TC, sum of OC+EC), carbon fractions determined by thermal or thermal-optical analysis methods (OC1, OC2, OC3, OC4, PC, EC1, EC2, EC3) as well as can be analyzed in the laboratory for individual organic species by a range of thermal analysis and/or extraction/analysis methods would provide means for much improved monitoring of the environment.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A filter having a fibrous ceramic component and a coating treated with inert nanoparticles or vapor deposited inerting agent for monitoring ambient environments for determination of carbon fractions.

2. The filter of claim 1 having a coating containing at least one transition metal.

3. The filter of claim 1 having a coating containing an inorganic compound that does not decompose below 1100 degrees and is inert.
